(19) United States
(12) Patent Application Publication
(10) Pub. No.: US 2008/0201759 A1
(43) Pub. Date: Aug. 21, 2008

(54) VERSION-RESILIENCE BETWEEN A MANAGED ENVIRONMENT AND A SECURITY POLICY

(75) Inventors: Michael D. Downen, Sammamish, WA (US); Darryn O. Lavery, Seattle, WA (US); Adriaan W. Canter, Seattle, WA (US); Sameer V. Bhangar, Seattle, WA (US); Thomas E. Quinn, Seattle, WA (US); Justin Kwak, Redmond, WA (US); David A. Whitechapel, Seattle, WA (US); Jeff Young, Snoqualmie, WA (US); Shawn Farkas, Kirkland, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/675,611

(22) Filed: Feb. 15, 2007

(51) Int. Cl. G06F 17/00

(52) U.S. Cl. 726/1

(57) ABSTRACT

A method and system for enforcing a security policy that is version-independent of a managed environment when loading custom code for a host application is provided. A security system of the managed environment receives an identifier of custom code to be loaded by the host application. Before loading the identified custom code, the managed environment enforces the security policy using the security system. The security system applies the security policy expressed using a version-independent indication of identifiers of untrusted custom code. If the security system determines that the trust of the custom code is unknown, then the security system requests a trust manager associated with the host application to enforce a host application-specific security policy. When the custom code is trusted, the managed environment loads the custom code.

### BACKGROUND

Developers of many application programs (“applications”) implement the applications so that they can be customized by third parties. To customize an application, a third party develops custom code (e.g., add-ins and document-level customizations) that uses functionality exposed by the application. The custom code may improve the usability of the applications or provide additional functionality (e.g., domain-specific functionality). Such applications are referred to as “host applications” because the custom code is hosted within the process of the application. Developers of applications typically want to encourage the development of custom code for their applications to increase the demand for their applications. As a result, such developers may provide “custom code runtimes” that facilitate the development of custom code. A runtime is code that is loaded along with custom code and provides services to the custom code. These services may include higher-level functionality than exposed by the application or may include domain-specific functionality. When an application is to load and start the execution of custom code, the application may load the runtime and direct the runtime to load and start the execution of the custom code.

Because of the ease of developing custom code as “managed code,” many applications support the execution of custom code in the .NET Framework provided by Microsoft Corporation. The .NET Framework provides a managed environment via a common language runtime (“CLR”) that provides high-level operating system-type services to the managed programs (including custom code and applications) and serves as an execution engine for managed programs. The CLR or managed environment ensures that managed programs do not take any unauthorized action. As such, the CLR acts as a “sandbox” within which managed programs execute. The CLR provides application domains (“appdomains”) in which different managed programs can execute to help ensure that an errant managed program will not unduly affect the execution of another managed program.

In order to execute a managed application on a computing system, the application needs to be deployed to the computing system. An application can either be statically or dynamically deployed. With static deployment, the application is installed on the computing system independently of when the application is to be executed within the managed environment. With dynamic deployment, a managed application can be dynamically downloaded and installed within the .NET Framework of the computing system as needed. Microsoft's ClickOnce deployment technology provides such dynamic deployment of managed applications. Dynamic deployment allows a hosting program executing on a computing system to dynamically deploy a managed application to that computer system. As an initial step, a managed application that is to be dynamically deployed needs its application manifest (or an assembly manifest) published to a deployment server. (The application manifest may be identified in a deployment manifest that also identifies the version of the custom code identified by the application manifest.) The application manifest specifies the location of the components of the managed application (e.g., on a server other than the deployment server), identifies the provider of the managed application, and provides security requirements needed to execute the managed application. The hosting program is then provided with the identifier (e.g., URL) of the application manifest. To deploy the application program, the hosting program uses the manifest identifier to retrieve the manifest from the deployment server. The hosting program can then download the components specified in the manifest, install the managed application within the .NET Framework, and start the execution of the managed application in an appdomain that is separate from the appdomain of the hosting program. To help the hosting program with deploying managed applications, the ClickOnce deployment technology provides an in place hosting manager (“IPHM”) class. The hosting program instantiates an in-place hosting manager object and requests the object to install the managed application specified by the application manifest. The in-place hosting manager object may help ensure that the managed application can be trusted (e.g., by comparing the provider to lists of trusted or untrusted providers). The in-place hosting manager object may also ensure that the managed application executes with the security level specified in the application manifest. The in-place hosting manager object may cache the downloaded managed application so that it can subsequently load the managed application without having to download it again from a server. As needed, the in-place hosting manager object will automatically remove managed applications from the cache. The in-place hosting manager object may also ensure that the most recent version of a managed application is loaded.

The .NET Framework provides Code Access Security (“CAS”) that allows an administrator to define the security policy of an application. The managed environment loads CAS and uses it to enforce the security policy. If the application is a host application, then the custom code runtime for the host application will typically use the CAS loaded by the managed environment to enforce the security policy for any custom code that is loaded. The managed environment (e.g., CLR) and CAS are versioned in the sense that if CLR v1.1 is loaded into the process of a host application, the CLR will use CAS v1.1 as its security mechanism. Similarly, if CLR v2.0 is loaded, it will use CAS v2.0 as its security mechanism. This versioning may present problems for host applications when multiple versions of the CLR are installed on a computer system. In particular, some host applications may be programmed to load the most recent version of the CLR, which uses the most recent version of the CAS. For example, if CLR v1.1 and v2.0 are installed onto a computer system and an application loads CLR v2.0, then the CLR will use CAS v2.0. An administrator, however, may have defined the security policy using CAS v1.1, but may not have had the time to convert the security policy to CAS 2.0. Since CAS 2.0 does not have the desired security policy defined, the CLR will fail to load any custom code for the host application. Thus, no custom code will be allowed to execute until the administrator defines the security policy using CAS 2.0.

### SUMMARY

A method and system for enforcing a security policy that is version-independent of a managed environment when loading custom code for a host application is provided. A security system of the managed environment receives an identifier of custom code to be loaded by the host application. Before loading the identified custom code, the managed environment enforces the security policy using the security system. The security system applies the security policy expressed using version-independent indications of identifiers of trusted custom code. The security policy may also be expressed using a version-independent indication of certifications of custom code that are trusted. For example, a version-independent indication of certifications may be a list indicating trusted and untrusted certifications. Whenever the security system cannot determine that custom code is trusted, the managed environment suppresses the loading of the custom code. If the security system determines that the trust of the custom code is unknown, then the security system requests a trust manager associated with the host application to enforce a host application-specific security policy. When the trust manager indicates that the custom code is trusted, the managed environment loads the custom code. Otherwise, it suppresses the loading of the custom code.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram that illustrates components of a custom code deployment system in one embodiment that uses a security system with a security policy that is version-independent of the managed environment.

FIG. 2 is a block diagram that illustrates use of the deployment system by a host application in a managed environment that is version-independent of the security policy in one embodiment.

FIG. 3 is a flow diagram that illustrates the processing of the enforce security policy component of the managed environment in one embodiment.

### DETAILED DESCRIPTION

A method and system for enforcing a security policy that is version-independent of a managed environment when loading custom code for a host application is provided. In one embodiment, a security system of the managed environment receives an identifier of custom code to be loaded by the host application. For example, the host application may identify from a system registry the URL of a manifest of custom code to be automatically loaded when the host application starts up. The host application may then start the managed environment and may provide the identifiers of the custom code to a loading component of the managed environment. Before loading the identified custom code, the managed environment enforces the security policy using the security system. (Alternatively, the security system may enforce the security policy only when custom code is installed or first loaded, rather than every time the custom code is loaded for execution.) The security system applies the security policy expressed using a version-independent indication of identifiers of trusted custom code. For example, a version-independent indication of identifiers may be a list of the identifiers of trusted custom code. The list may indicate which servers are considered to serve trusted custom code. The security policy may also be expressed using a version-independent indication of certifications of custom code that are trusted. For example, a version-independent indication of certifications may be a list indicating trusted and untrusted certifications. The security system identifies the certification for custom code and determines whether the custom code is trusted or untrusted, or whether its trust is unknown. If the certification indicates that the custom code is trusted, then the managed environment loads the custom code. Whenever the security system determines that custom code is untrusted, the managed environment suppresses the loading of the custom code. For example, when the identifier or the certification of the custom code indicates that it is untrusted, the managed environment will not load the custom code. If the security system determines that the trust of the custom code is unknown, then the security system requests a trust manager associated with the host application to enforce a host application-specific security policy. When the trust manager indicates that the custom code is trusted, the managed environment loads the custom code. Otherwise, it suppresses the loading of the custom code. The indications of identifiers and certifications and the trust manager are independent of the version of the managed environment. That is, the security system of different versions of the managed environment can enforce the same security policy without modification to the security policy. Moreover, if an administrator modifies a security policy, the security system of different versions of the managed environment can enforce that modified security policy. In this way, a new version of the managed environment will trust and not trust the same custom code as the old version of the managed environment and consequently load or not load the same custom code.

In one embodiment, the managed environment dynamically deploys custom code for execution within a host application based on the security system indicating whether the custom code is trusted, untrusted, or of unknown trust. One skilled in the art will, however, appreciate that the security system that implements the version independence may be used in a managed environment that does not dynamically deploy custom code (i.e., the custom code is statically deployed prior to load time). A deployment system of the managed environment is developed by adapting an existing deployment system for deploying managed applications to also deploy custom code. To support the deployment of custom code, the deployment system augments the application manifest used for deploying managed applications to include information describing how the host application is to use the custom code, referred to as host manifest information. The host manifest information may describe various entry points into the custom code and may include host-specific information such as the names of the host application that can execute the custom code. Such host-specific information can be used by a host application, for example, to ensure that only custom code specifically developed for that host application is executed by the host application. The deployment system provides the host manifest information to the host application. The deployment system also reports the progress of the downloading of the manifest and the custom code to the host application. The host application can then perform appropriate host-specific processing. For example, a host application may display a dialog box indicating the progress of the download of the manifest and the custom code or may update registry entries. The deployment system uses the security system to verify the trust of the custom code. If the security system determines that the custom code is trusted, then the deployment system will download, install, and load the custom code. If the security system determines that the custom code is untrusted or of unknown trust, the deployment system may suppress the downloading and/or installing of the custom code. The deployment system also allows the host application to control the uninstalling of the custom code. In one embodiment, the deployment system may be adapted to deploy both managed applications and custom code that is implemented as managed code. In such an embodiment, the deployment system may distinguish between a managed application and custom code that is to be deployed based on the presence of host manifest information in the manifest. The deployment system may be adapted to provide the host manifest information to the host application when custom code is being downloaded. The deployment system may be adapted to automatically verify the trust of managed applications but rely on the host application to verify the trust of custom code. The deployment system may also automatically uninstall managed applications (remove them from its cache) but rely on the host application to uninstall custom code. In this way, the deployment system allows custom code that is not an executable to be dynamically deployed to computer systems as requested by host applications. A deployment management system is described in U.S. application Ser. No. ______ (Attorney Docket No. 41826.8387US) entitled “Dynamic Deployment of Custom Code” and filed concurrently with this application, which is hereby incorporated by reference.

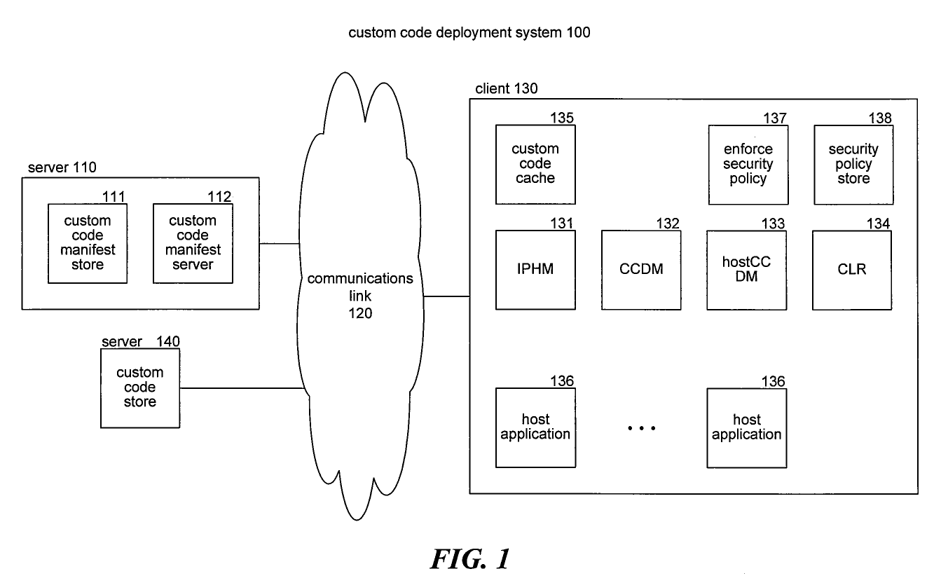

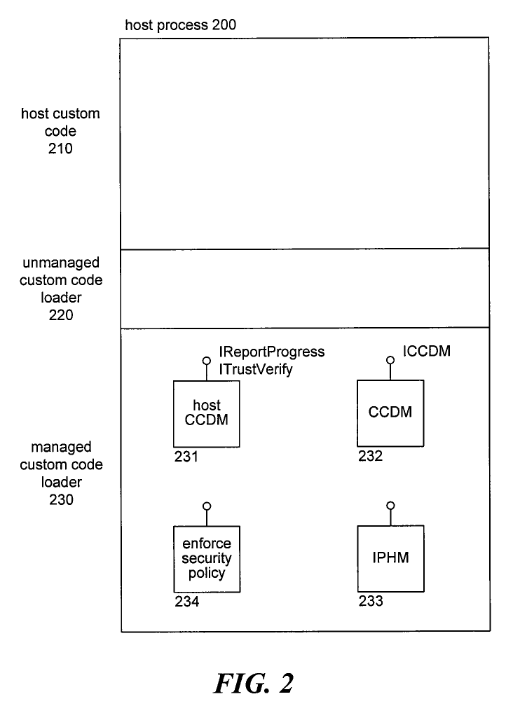

FIG. 1 is a block diagram that illustrates components of a custom code deployment system in one embodiment that uses a security system with a security policy that is version-independent of the managed environment. The custom code deployment system 100 includes a server component 110 and a client component 130 connected via a communications link 120. The server component executes on a server computer system and includes a custom code manifest store 111 and a custom code manifest server component 112. The custom code manifest store contains the manifests of the custom code that has been published to the deployment system. The custom code manifest server component receives requests to publish custom code and requests for manifests of the published custom code. Upon receiving a request for a manifest, the custom code manifest server component retrieves the manifest from the custom code manifest store and provides the retrieved manifest to the client component of the requesting computer system. The manifest identifies the location where the custom code is stored, such as in a custom code store at server 140. The client component of the deployment system includes an in-place hosting manager component (“IPHM”) 131, a custom code deployment manager component (“CCDM”) 132, a host custom code deployment manager component (“hostCCDM”) 133, a common language runtime component (“CLR”) 134, a custom code cache 135, host applications 136, an enforce security policy component 137, and a security policy store 138. The security policy store represents the collection of security policies such as inclusion lists, code for evaluating certificates, and so on. These components are described in detail with reference to FIG. 2.

The computing devices on which the security system may be implemented may include a central processing unit, memory, input devices (e.g., keyboard and pointing devices), output devices (e.g., display devices), and storage devices (e.g., disk drives). The memory and storage devices are computer-readable media that may be embedded with computer-executable instructions that implement the security system. In addition, the instructions, data structures, and message structures may be stored or transmitted via a data transmission medium, such as a signal on a communications link. Various communications links may be used, such as the Internet, a local area network, a wide area network, or a point-to-point dial-up connection.

The security system may be implemented on various computing systems or devices including personal computers, server computers, multiprocessor systems, microprocessor-based systems, network PCs, minicomputers, mainframe computers, distributed computing environments that include any of the above systems or devices, and the like. The security system may be used by various computing systems such as personal computers, cell phones, personal digital assistants, consumer electronics, home automation devices, and so on.

The security system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

FIG. 2 is a block diagram that illustrates use of the deployment system by a host application in a managed environment that is version-independent of the security policy in one embodiment. The host application is developed to invoke a loader that is responsible for loading the custom code. In such a case, the deployment system can be implemented by the loader without modification to the custom code of the host application. In this example, the host application executes as a host process 200 that includes host code 210 executing as unmanaged code, and an unmanaged custom code loader component 220 executing as unmanaged code, and a managed custom code loader component 230 executing as managed code. When the host application wants to load custom code, the host application invokes the unmanaged custom code loader component, passing the identification of the manifest of the custom code to be loaded. The unmanaged custom code loader component starts the managed environment within the host process and invokes the managed custom code loader component, passing the manifest identifier. The managed custom code loader component then instantiates a host custom code deployment manager object (hostCCDM) 231. The host custom code deployment manager object (hostCCDM) provides an implementation of a verify trust interface that is an example of a trust manager that provides methods for verifying the trust of custom code, and a report progress interface that provides methods for receiving notifications of the progress of the downloading of a manifest and custom code. The host custom code deployment manager object (hostCCDM) may be alternatively implemented as two objects: one for the verify trust interface and the other for the report progress interface. The implementation of the host custom code deployment manager object (hostCCDM) allows for processing that is specific to the host application or at least specific to the managed custom code loader. For example, when progress on the installation is reported, the implementation of the report progress interface may display a progress bar or add registry entries for the custom code. The managed custom code loader component then instantiates a custom code deployment manager object (CCDM) 232. The custom code deployment manager object (CCDM) provides methods for installing and uninstalling custom code. When the custom code deployment manager object (CCDM) is instantiated, it is provided with the verify trust and the report progress interfaces along with the manifest identifier. The managed custom code loader component then invokes the install method of the custom code deployment manager object (CCDM).

When the install method is invoked, the custom code deployment manager object (CCDM) instantiates an in-place hosting manager object 233, passing the manifest identifier of the custom code to be downloaded. The in-place hosting manager object provides methods for downloading the manifest and the custom code and reports progress of the download to the custom code deployment manager object (CCDM) via events. The custom code deployment manager object (CCDM), upon receiving an event, invokes a method of the report progress interface to notify the host custom code deployment manager object (hostCCDM) to pass the notification to the host application (or more generally to notify the invoking custom code). The custom code deployment manager object (CCDM) invokes a get manifest method of the in-place hosting manager object to download the manifest of the custom code. The get manifest method returns the manifest, including the host manifest information, using events through which it reports progress of the download. The custom code deployment manager object (CCDM) enforces a security policy that is independent of the version of the managed environment by invoking an enforce security policy component 234 that implements the security system. Assuming the security system determines that the custom code is trusted, the custom code deployment manager object (CCDM) invokes the download application method of the in-place hosting manager object to download the application identified by the manifest. The download application method reports progress of the download of the application to the custom code deployment manager object (CCDM) via events. The custom code deployment manager object (CCDM) then notifies the host custom code deployment manager object (hostCCDM) of the progress via the report progress interface. The custom code deployment manager object (CCDM) is notified of completion of the download by an event, notifies the host custom code deployment manager object (hostCCDM) via the report progress interface, and causes return to the host application. The host application can then start the execution of the custom code.

The following tables illustrate sample methods and events of various classes of the deployment system.

TABLE 1

| | | |
|---|---|---|
| IPHM | Methods | DownloadApplicationAsync |
| | | GetManifestAsync |
| | | UninstallCustomCode |
| | Events | DownloadApplicationCompleted |
| | | DownloadProgressChanged |
| | | GetManifestCompleted |

The IPHM class of Table 1 may be an implementation of the Windows InPlaceHostingManager that supports the dynamic download and installation of a managed application that has been extended to support the download and installation of custom code. The GetManifestAsync method downloads the manifest and returns it to the invoking code asynchronously and raises a GetManifestCompleted event when the operation has either completed or encountered an error. The DownloadApplicationAsync method downloads an application or custom code asynchronously and raises a DownloadProgressChanged event to report the progress of a download and a DownloadApplicationCompleted event when the download has either completed or encountered an error. The UninstallCustomCode method is called to uninstall the custom code from the download cache.

TABLE 2

| | | |
|---|---|---|
| CCDM | Methods | CCDM (manifestURI, ITrustManager) |
| | | CCDM (manifestURI, ITrustManager, |
| | | IReportProgress) |
| | | InstallCC( ): CCInformation |
| | | UninstallCC( ): Void |

The CCDM class of Table 2 provides services needed by a host application to download and install custom code. These services include downloading the custom code, verifying certificate signatures, and uninstalling. The class uses the manifestURI to locate the manifest for the custom code. The class uses a VerifyCCTrust method of the ITrustManager interface for performing host-specific verification of trust when invoked by the security system. The VerifyCCTrust method is passed evidence (e.g., final manifest location, original manifest location, product name, and signature result) to determine whether the custom code can be trusted. The class implements a call-back model using the IReportProgress interface to notify the host application of the progress in installing the custom code. The class invokes the methods of the IReportProgress interface to report various events that may include Downloaded, Installed, Installing, ManifestDownloaded, Uninstalled, and so on. The host application can take appropriate actions based on the progress. For example, add-ins for one application may require registry keys to be created, and add-ins for another type of application may require form regions to be registered. These host-specific actions are designed to be implemented in the host custom code deployment manager for the application (i.e., hostCCDM class). The CCInformation class contains information needed to start the execution of the custom code. The custom code loader may need an AppDomainSetup object and the host-specific application manifest (with entry point information).

TABLE 3

| | | |
|---|---|---|
| hostCCDM | Methods | hostCCDM (manifestFullLocationPath, |
| | | manifestName) |
| | | hostCCDM (manifestURI) |
| | | VerifyCCTrust (evidence) |
| | | OnCC{Event} (e.g., “Event” includes |
| | | Downloaded, Installed, Installing, |
| | | ManifestDownloaded, Uninstalled) |

The hostCCDM class of Table 3 allows the custom code loader to identify the manifest of the custom code to be loaded, verify the trust of the custom code, and receive notifications of various events. The class may provide host-specific behavior. For example, the constructors for the class may check an exclusion list, an inclusion list, and an untrusted sites list. As another example, when a hostCCDM object receives a notification of an event, it can add entries to the system registry. The constructors for this class may identify the location of the manifest using either a URI or a manifest path name. A document-level customization may provide the URI of the manifest, and an application add-in may provide the manifest path name of a registry entry that contains the URI of the manifest. The VerifyCCTrust method is provided through an ITrustManager interface and is invoked by a CCDM object to verify the trust of the custom code during installation. The OnCC{Event} methods are provided though an IReportProgress interface and are invoked by a CCDM object to report events to the hostCCDM object. The hostCCDM object can then perform host-specific processing or at least loader-specific processing when the loader is shared by multiple host applications.

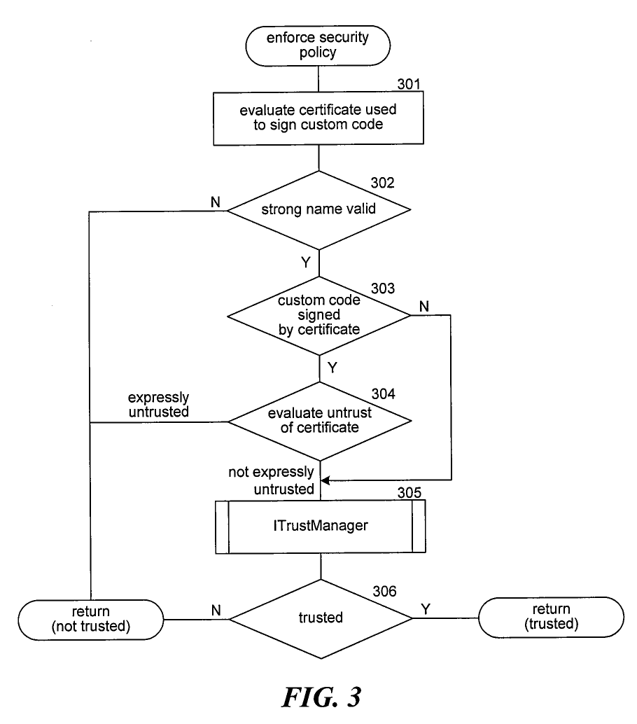

FIG. 3 is a flow diagram that illustrates the processing of the enforce security policy component of the managed environment in one embodiment. In decision block 301, the component evaluates the certificate used to sign the custom code. In decision block 302, if the certificate is a strong name that is valid, then the component continues at block 303, else the component returns an indication that the custom code is not trusted. The strong name for custom code consists of five parts: a public key, a simple name, a version, an optional culture, and an optional processor architecture. Custom code may be signed using a strong name. In decision block 303, if the custom code is signed by a valid certificate, then the component continues at block 304, else the component continues at block 305. In decision block 304, if an evaluation of the untrust of the certificate indicates that the custom code is expressly untrusted, then the component returns an indication that the custom code is untrusted, else the component continues at block 305. In block 305, the component invokes the verify trust method of the ITrust Manager to provide the host application an opportunity to verify the trust of the custom code. The host application may check various inclusion lists and exclusion lists, such as those used by an Internet browser. In decision block 306, if the host application indicates that the custom code is trusted, then the component returns an indication that the custom code is trusted, else the component returns an indication that the custom code is not trusted.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A computing system for enforcing a security policy when loading custom code for a host application, the custom code executing in a managed environment, the security policy being version-independent of the managed environment, comprising:
a custom code loading component of the managed environment that
receives an identifier of custom code to be loaded by the host application;
applies the security policy expressed using a version-independent indication of identifiers of untrusted custom code;
when the applied security policy does not indicate that the identified custom code is untrusted, requests a trust manager to apply a host application-specific security policy to the identified custom code to determine whether the identified custom code is trusted;
when it is determined that the identified custom code is untrusted or it cannot be determined whether the identified custom code is trusted, suppresses the loading of the custom code; and
when it is determined that identified custom code is trusted, loads the identified custom code.

2. The computing system of claim 1 wherein the security policy is expressed using an administrator-supplied list of untrusted identifiers.

3. The computing system of claim 1 wherein the managed environment is provided by the .NET Framework.

4. The computing system of claim 1 wherein the security policy is further expressed using an indication of certifications of the custom code that are trusted and untrusted.

5. The computing system of claim 4 wherein the indication of certifications includes an administrator-supplied list of trusted certifications.

6. The computing system of claim 4 wherein the indication of certifications includes an administrator-supplied list of untrusted certifications.

7. The computing system of claim 1 including a custom code deployment manager of the managed environment that downloads the custom code from a server and installs the custom code on the computing system when it is determined that the custom code is trusted.

8. The computing system of claim 1 wherein the host application-specific security policy is expressed using a list of identifiers of trusted custom code.

9. A computer-readable medium embedded with instructions for controlling a computer system to enforce a security policy for custom code for a host application, the custom code for execution in a managed environment, by a method comprising:
determining whether the custom code is trusted or untrusted by applying the security policy expressed using a version-independent indication of identifiers of trusted and untrusted custom code;
when it cannot be determined whether the custom code is trusted or untrusted, requesting the host application to apply a host application-specific security policy to the custom code to determine whether the custom code is trusted; and
when it is determined that identified custom code is trusted, loading the custom code
wherein different versions of the managed environment can enforce the security policy without modification to the security policy.

10. The computer-readable medium of claim 9 wherein the security policy is expressed using an administrator-supplied indication of untrusted custom code.

11. The computer-readable medium of claim 9 wherein the security policy is enforced when the managed environment is requested to load the custom code.

12. The computer-readable medium of claim 9 wherein the security policy is expressed using an indication of certifications of trusted and untrusted custom code.

13. The computer-readable medium of claim 12 wherein the indication of certifications includes a computer system-specific list indicating trusted certifications.

14. The computer-readable medium of claim 12 wherein the indication of certifications includes a computer system-specific list indicating untrusted certifications.

15. The computer-readable medium of claim 9 wherein a custom code deployment manager of the managed environment downloads the custom code from a server and installs the custom code on the computer system when it is determined that the custom code is trusted.

16. The computer-readable medium of claim 9 wherein the security policy is expressed as a computer-system specific list indicating trusted and untrusted custom code by custom code identifier and by custom code certification, and wherein a custom code deployment manager downloads the custom code from a server and installs the custom code on the computer system when it is determined that the custom code is trusted.

17. A method in a computing device for enforcing a security policy for custom code to be executed in a managed environment of a host application, the security policy being independent of version of the managed environment, the method comprising:
when the custom code is to be loaded by the managed environment, determining by the managed environment whether the custom code is untrusted in accordance with the security policy;
when it is not determined that the custom code is untrusted, determining by a trust manager that is specific to the application whether the custom code is trusted in accordance with the security policy; and
when it is determined that identified custom code is trusted, loading the custom code
wherein different versions of the managed environment can use the same security policy.

18. The method of claim 17 wherein the security policy is expressed using a computing device-specific list indicating identifiers of untrusted custom code.

19. The method of claim 17 wherein the security policy is expressed using a computing device-specific list indicating certifications of trusted and untrusted custom code.

20. The method of claim 17 wherein the security policy is expressed using a computing device-specific list indicating identifiers of untrusted custom code and certifications of trusted and untrusted custom code and an application-specific trust manager for determining whether custom code is trusted, and wherein a custom code deployment manager downloads the custom code from a server and installs the custom code on the computing device when it is determined that the custom code is trusted.
